(19) United States
(12) Patent Application Publication
(10) Pub. No.: US 2017/0286924 A1
(43) Pub. Date: Oct. 5, 2017

(54) EVENT INFORMATION PRESENTING DEVICE AND EVENT INFORMATION PRESENTING METHOD

(71) Applicant: ALPINE ELECTRONICS, INC., Tokyo (JP)

(72) Inventor: Chiaki Tazono, Iwaki-shi (JP)

(73) Assignee: ALPINE ELECTRONICS, INC., Tokyo (JP)

(21) Appl. No.: 15/410,310

(22) Filed: Jan. 19, 2017

(30) Foreign Application Priority Data
Mar. 31, 2016 (JP) 2016-073465

(51) Int. Cl. G06Q 20/10; G01C 21/36; G01C 21/34; G06F 17/30; H04L 29/08

(52) U.S. Cl. CPC G06Q 20/10; G06F 17/3087; G06F 17/30867; H04L 67/02; H04L 67/18; G01C 21/34; G01C 21/3682; G06Q 50/01

(57) ABSTRACT

A portable terminal device includes an event information acquiring unit configured to analyze text information which is present over the Internet and to acquire event information; an event specifying information extracting unit configured to extract event specifying information for specifying an event which is held on the basis of the acquired event information; an additional information acquiring unit configured to acquire additional information including an image corresponding to the event from a specific web site via the Internet by designating the extracted event specifying information; and a proposal information providing unit configured to create proposal information using the event information and the additional information and to provide the created proposal information to a user.

### RELATED APPLICATION

The present application claims priority to Japanese Patent Application Number 2016-073465, filed Mar. 31, 2016, the entirety of which is hereby incorporated by reference.

### BACKGROUND

### 1. Field of the Invention

The present invention relates to an event information presenting device and an event information presenting method that acquire and present event information via the Internet.

### 2. Description of the Related Art

Conventionally, a system that acquires a user's taste or geographical location from an information source over the Internet, determines a geographically localized recommendation, and presents the determined recommendation to a user is known (for example, see JP 2014-510323 A). Photographs provided by the recommendation, based on details of the recommendation, are selected and used.

Specific event information can be acquired and presented to a user using the system disclosed in JP 2014-510323 A, but it is difficult to determine whether an image such as a photograph included in event information acquired via the Internet constitutes a part of the event information (indicates details of an event) or has a purpose of advertisement not directly relevant to the event information. In general, when a user accesses an application programming interface (API) of a specific web site over the Internet and acquires event information from the web site, a source of the event information prepares photographs and the like to be provided as event information and it is thus considered that there is no particular problem even in providing images included in the event information to a user without any change. However, an image included in event information acquired from a web site which is not equipped with an API is often the above-mentioned advertisement or the like, and thus unnecessary information is provided to a user when the image is used in the event information without any change, which is not preferable. It can also be considered that an individual loader (an event information acquiring program) for acquiring event information including photographs is created for each web site not equipped with an API, but this configuration is not realistic in view of the number of working steps or costs when there are many web sites as a source of event information or web sites are newly added. Particularly, web sites which can be used free by users are often not equipped with an API, and thus there is a demand for a technique capable of reliably acquiring useful event information effectively using such web sites.

### SUMMARY

The present disclosure is made in consideration of the above-mentioned circumstances and an object thereof is to provide an event information presenting device, an event information presenting method, and an event information presenting program that can provide useful event information to a user via the Internet. Another object of the present disclosure is to provide an event information presenting device, an event information presenting method, and an event information presenting program that do not need to create an individual program for each web site and can reliably acquire event information.

In order to achieve the above-mentioned objects, an event information presenting device according to the present disclosure includes: an event information acquiring unit configured to analyze text information which is present over the Internet and to acquire event information; an event specifying information extracting unit configured to extract event specifying information for specifying an event which is held on the basis of the event information; an additional information acquiring unit configured to acquire additional information corresponding to the event from a specific web site via the Internet by designating the event specifying information; and a proposal information providing unit configured to create proposal information using the event information and the additional information and to provide the created proposal information to a user.

An event information presenting method according to the present disclosure includes: causing an event information acquiring unit to analyze text information which is present over the Internet and to acquire event information; causing an event specifying information extracting unit to extract event specifying information for specifying an event which is held on the basis of the event information; causing an additional information acquiring unit to acquire additional information corresponding to the event from a specific web site via the Internet by designating the event specifying information; and causing a proposal information providing unit to create proposal information using the event information and the additional information and to provide the created proposal information to a user.

An event information presenting program according to the present disclosure causes a computer to function as: an event information acquiring unit configured to analyze text information which is present over the Internet and to acquire event information; an event specifying information extracting unit configured to extract event specifying information for specifying an event which is held on the basis of the event information; an additional information acquiring unit configured to acquire additional information corresponding to the event from a specific web site via the Internet by designating the event specifying information; and a proposal information providing unit configured to create proposal information using the event information and the additional information and to provide the created proposal information to a user.

It is desirable that the additional information include an image.

By acquiring event information which is present widely over the Internet, specifying an event on the basis of the event information, and additionally designating a specific web site, it is possible to easily acquire additional event information (additional information) corresponding to a specific event from the specific web site. Particularly, by restricting a web site (which is not limited to one web site) from which an image is acquired, it is possible to easily exclude a useless image such as an advertisement and it is thus possible to provide useful event information to a user via the Internet. It is not necessary to create an individual program for each of many web sites present over the Internet and it is possible to reliably acquire useful event information.

It is desirable that the additional information acquiring unit acquire the additional information from a web site which is equipped with an application programming interface. In web sites equipped with the application programming interface (API), since event-relevant photographs and the like to be provided to users are often prepared, it is possible to reliably acquire useful event information such as photographs corresponding to the event by acquiring the additional information from such web sites.

It is desirable that the additional information acquiring unit acquire the additional information from a web site which provides a social networking service. In web sites providing the social networking service (SNS), since event-relevant photographs which are contributed by a third party or the like are widely available, it is possible to reliably acquire photographs corresponding to an event by acquiring the additional information from such web sites.

It is desirable that the event information presenting device further include an event information selecting unit configured to select some event information from a plurality of pieces of the event information acquired by the event information acquiring unit using a predetermined selecting condition and the event specifying information extracting unit extract the event specifying information from the event information selected by the event information selecting unit. Accordingly, it is possible to provide a user with proposal information which is appropriately and carefully selected from many acquired pieces of event information.

It is desirable that the event information selecting unit select the event information by restricting a date of an event. Accordingly, it is possible to provide a user with proposal information for an event which is held on an available date.

It is desirable that the event information selecting unit select the event information on the basis of a user's current location or registered address. Accordingly, it is possible to provide a user with proposal information for an event which is held in an available place.

It is desirable that the event information selecting unit select the event information on the basis of a moving direction or a destination of a user's vehicle. Accordingly, it is possible to provide a user with proposal information for an event to which the user can travel by car.

It is desirable that the event information selecting unit select the event information by restriction to events in which a participation fee or a usage fee is equal to or less than a predetermined amount of money. Accordingly, it is possible to provide a user with proposal information for an event which is free of charge or requires little cost.

It is desirable that the event information presenting device further include a hobby and taste specifying unit configured to specify a user's hobby or taste and the event information acquiring unit acquire event information relevant to a user's hobby or taste specified by the hobby and taste specifying unit. Accordingly, it is possible to provide a user with proposal information for an event to which there is a high possibility that the user wants to attend.

It is desirable that, when an event corresponding to the additional information is repeatedly held a plurality of times, a photograph is included in the additional information, and the photograph is taken to correspond to an event held prior to a previous event older than an event which is currently held, the proposal information providing unit provide the proposal information such that a user sees the effect. Accordingly, when only an old photograph is available, it is possible to prevent a user from mistaking the old photograph for a newest photograph.

It is desirable that location information indicating a venue of an event corresponding to the proposal information provided from the proposal information providing unit be transmitted to an onboard device that performs a navigation operation of guiding traveling of a vehicle along a travel route to a destination corresponding to the location information. Accordingly, a user provided with proposal information can cause a vehicle to travel to a venue of an event without performing a complicated operation (for example, an operation of inputting an address of the event or the like to the onboard device while watching the proposal information).

### BRIEF DESCRIPTION OF THE DRAWINGS

FIG. 1 is a diagram illustrating an entire configuration of an event information acquiring system including a portable terminal device according to an embodiment of the present invention;

FIG. 2 is a diagram illustrating a detailed configuration of the portable terminal device;

FIG. 3 is a diagram illustrating a detailed configuration of an onboard device;

FIG. 4 is a flowchart illustrating an operation flow in the portable terminal device until the portable terminal device acquires information on an event and provides proposal information;

FIG. 5 is a diagram illustrating a display example of proposal information;

FIG. 6 is a flowchart illustrating an operation flow of selecting event information in a modified example; and

FIG. 7 is a flowchart illustrating an operation flow of transmitting location information indicating an event venue to the onboard device in a modified example.

### DETAILED DESCRIPTION

Hereinafter, an event information acquiring system according to an embodiment to which an event information presenting device, an event information presenting method, and an event information presenting program according to the present disclosure are applied will be described with reference to the accompanying drawings.

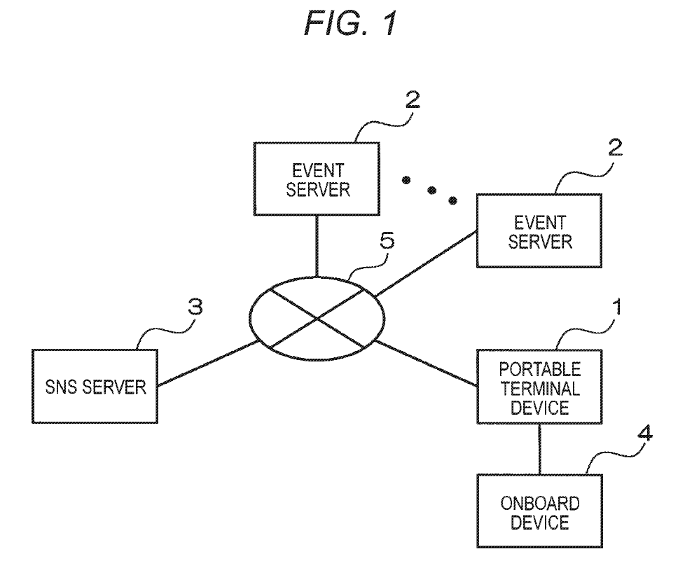

FIG. 1 is a diagram illustrating a configuration of an event information acquiring system including a portable terminal device according to an embodiment of the present invention. The event information acquiring system according to this embodiment includes a portable terminal device 1 that is carried by a user, and an event server 2 and an SNS server 3 that are connected to the portable terminal device 1 via a network 5. The portable terminal device 1 is connected to an onboard device 4 mounted on a vehicle if necessary.

The portable terminal device 1 includes an Internet interface, acquires information on an event via the Internet, and presents the acquired information to the user. The event server 2 is a server that provides a web site delivering information on an event, and the user can acquire information on a specific event and other information by accessing the web site via the Internet. The name “event server” means a server delivering information on an event and is not different from a general server providing a variety of information. The SNS server 3 is a server that provides a specific social networking service (SNS), and the user can acquire a variety of information such as an image such as a photograph by accessing an application programming interface (API) of a web site provided by the SNS server 3.

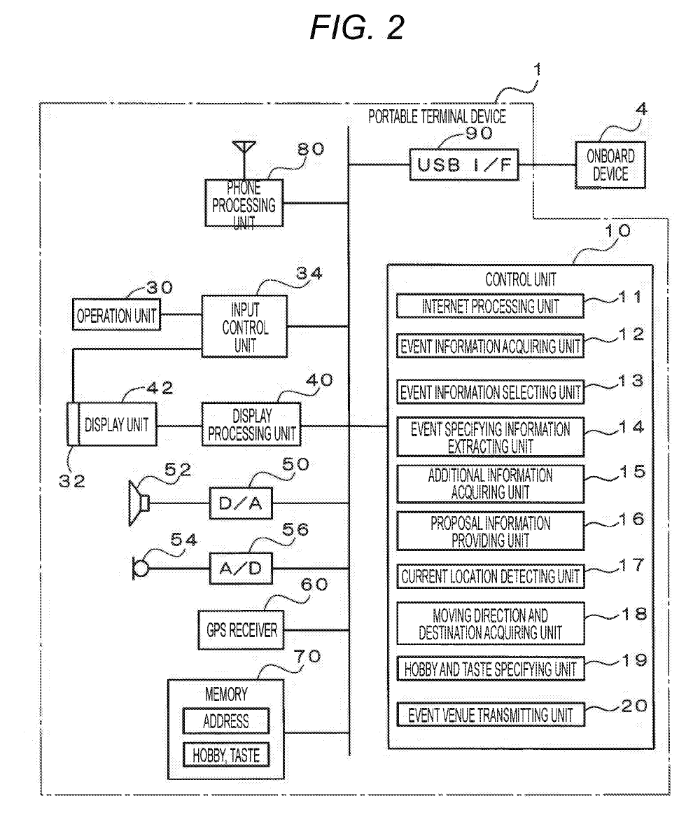

FIG. 2 is a diagram illustrating a detailed configuration of the portable terminal device 1. The portable terminal device 1 generally may be a smartphone and has an Internet accessing function, and the user can acquire information on an event by operating the portable terminal device when the user wants.

As illustrated in FIG. 2, the portable terminal device 1 includes a control unit 10, an operation unit 30, a touch panel 32, an input control unit 34, a display processing unit 40, a display unit 42, a digital-to-analog converter (D/A) 50, a speaker 52, a microphone 54, an analog-to-digital converter (A/D) 56, a global positioning system (GPS) receiver 60, a memory 70, a phone processing unit 80, and a universal serial bus (USB) interface unit (USB I/F) 90.

The control unit 10 functions to control the portable terminal device 1 as a whole, is configured to include a CPU, a RAM, and a ROM, and performs various operations as a computer by executing various application programs such as a program stored in the RAM or the ROM or an event information presenting program stored in the memory 70.

The operation unit 30 receives various operations from a user and includes various switches or operation knobs. The touch panel 32 is disposed to overlap a screen of the display unit 42 and detects a position on the screen which is touched by the user's finger. For example, a capacitance type touch panel is used as the touch panel 32, but a touch panel of other types (such as a resistive membrane type) may be used. The input control unit 34 monitors the operated states of the operation unit 30 and the touch panel 32, and detects details input by the user.

The display processing unit 40 outputs an image signal for displaying various operation screens or an input screen, and causes the display unit 42 to display the screens. The display unit 42 is constituted by a liquid crystal display device (LCD) or the like and displays operation details based on the operation unit 30 or the touch panel 32 or control details and processing details based on the control unit 10.

The digital-to-analog converter 50 converts incoming voice data or the like when the portable terminal device 1 is used as a phone into an analog signal and outputs the analog signal from the speaker 52. The microphone 54 collects speech from the user. The collected voice is converted into digital data by the analog-to-digital converter 56.

The GPS receiver 60 receives signals transmitted from multiple GPS satellites and outputs positioning data indicating a current location of the portable terminal device 1 at predetermined time intervals.

The memory 70 stores various application programs such as an event information presenting program as described above and also stores address information of the user who is an owner of the portable terminal device 1 or hobby and taste information indicating the user's hobby or taste. The hobby and taste information may simply be prepared on the basis of information indicating a hobby or taste input by the user, may be prepared on the basis of information read by the user at the time of accessing the Internet, may be prepared on the basis of a history of “proposal information” provided to the user according to the present disclosure, or may be prepared in combination thereof.

The phone processing unit 80 performs processes as a mobile phone. For example, the phone processing unit 80 processes outgoing and incoming calls with respect to a base station to perform a calling process, an Internet accessing process, or the like.

The USB interface unit 90 functions to input and output a signal between the portable terminal device 1 as a USB device (a target) and the onboard device 4 as a USB host via a USB cable as a connection line, and includes a USB target controller. The portable terminal device 1 and the onboard device 4 may be connected to each other in other wired or wireless manners.

The control unit 10 includes an Internet processing unit 11, an event information acquiring unit 12, an event information selecting unit 13, an event specifying information extracting unit 14, an additional information acquiring unit 15, a proposal information providing unit 16, a current location detecting unit 17, a moving direction and destination acquiring unit 18, a hobby and taste specifying unit 19, and an event venue transmitting unit 20.

The Internet processing unit 11 is embodied by executing an Internet accessing application. The Internet processing unit 11 has a web browser function, accesses the Internet using the phone processing unit 80, accesses web sites provided by various servers such as the event server 2 and the SNS server 3, and transmits and receives data to and from the various servers via the web sites.

The event information acquiring unit 12 analyzes text information which is present over the Internet and acquires event information. For example, the event information acquiring unit 12 acquires event information including text data by designating an event name, a date, a venue, and the like which are rough using a search engine to perform a searching operation. The acquired event information includes an event name, a date, a venue, a fee, and the like which are correct. The acquiring operation is performed on various web sites regardless of presence or absence of an API without accessing an API of a specific web site.

The event information selecting unit 13 selects some event information among a plurality of pieces of event information acquired by the event information acquiring unit 12 using a predetermined selecting condition. A specific example of the selecting condition will be described later.

The event specifying information extracting unit 14 extracts event specifying information for specifying an event which is held on the basis of the event information which is acquired by the event information acquiring unit 12 and selected by the event information selecting unit 13. For example, since a correct event name, a correct date, a correct venue, and the like for each event can be seen on the basis of the acquired event information, this data is extracted as the “event specifying information.”

The additional information acquiring unit 15 acquires additional information including an image such as a photograph corresponding to the event by designating the event specifying information extracted by the event specifying information extracting unit 14 and accessing an API of the specific web site provided by the SNS server 3. As the image acquired herein, a photograph or other images such as an advertisement not associated with the event can be excluded by acquiring the image using the API.

The proposal information providing unit 16 prepares proposal information using the event information acquired by the event information acquiring unit 12 and selected by the event information selecting unit 13 and the additional information (such as a photograph) acquired by the additional information acquiring unit 15 and provides the prepared proposal information to the user.

The current location detecting unit 17 detects a current location of the portable terminal device 1 on the basis of positioning data output from the GPS receiver 60.

The moving direction and destination acquiring unit 18 acquires moving direction and destination data when the moving direction and destination data indicating a moving direction of a vehicle equipped with the onboard device 4 or a destination of the vehicle is sent from the onboard device 4.

The hobby and taste specifying unit 19 specifies the user's hobby or taste on the basis of the hobby and taste information stored in the memory 70.

The event venue transmitting unit 20 transmits location information indicating a venue of the event corresponding to the proposal information provided by the proposal information providing unit 16 to the onboard device 4 connected to the portable terminal device 1.

The event information acquiring unit 12 corresponds to an event information acquiring unit, the event specifying information extracting unit 14 corresponds to an event specifying information extracting unit, the additional information acquiring unit 15 corresponds to an additional information acquiring unit, the proposal information providing unit 16 corresponds to a proposal information providing unit, the event information selecting unit 13 corresponds to an event information selecting unit, and the hobby and taste specifying unit 19 corresponds to a hobby and taste specifying unit.

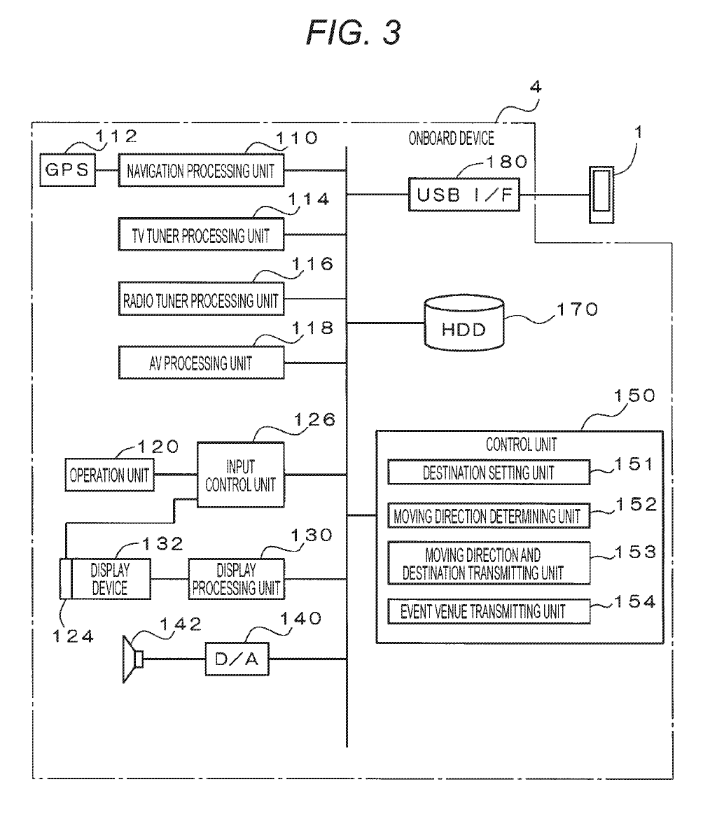

FIG. 3 is a diagram illustrating a detailed configuration of the onboard device 4. As illustrated in FIG. 3, the onboard device 4 includes a navigation processing unit 110, a TV tuner processing unit 114, a radio tuner processing unit 116, an AV processing unit 118, an operation unit 120, a touch panel 124, an input control unit 126, a display processing unit 130, a display device 132, a digital-to-analog converter (D/A) 140, a speaker 142, a control unit 150, a hard disk device (HDD) 170, and a USB interface unit (USB I/F) 180.

The navigation processing unit 110 performs a navigation operation of guiding traveling of a vehicle equipped with the onboard device 4 using map data stored in the hard disk device 170. The navigation operation is used along with the GPS receiver 112 for detecting a location of the vehicle, guiding traveling of the vehicle including displaying a map around the vehicle, route search and guidance in which a destination is designated, and an operation of searching and displaying nearby facilities. The detecting of the location of the vehicle may be performed in combination of an autonomous navigation sensor such as a gyro sensor or a vehicle speed sensor in addition to the GPS receiver 112.

The operation unit 120 functions to receive various operations from the user and includes various switches or operation knobs. A touch panel 124 is disposed to overlap a screen of the display device 132 and detects a position on the screen which is touched by the user's finger. The input control unit 126 monitors the operated states of the operation unit 120 and the touch panel 124, and detects details input by the user.

The display processing unit 130 outputs an image signal for displaying various operation screens or an input screen to cause the display device 132 to display the screens, and outputs an image signal for displaying an image screen corresponding to a broadcast signal received by the TV tuner processing unit 114 or an image screen reproduced by the AV processing unit 118 to cause the display device 132 to display the screens. The display device 132 is installed on the front side of a center between a driver seat and a passenger seat and is constituted, for example, by a liquid crystal display device (LCD).

The digital-to-analog converter 140 converts voice data or music data generated through the processes of the navigation processing unit 110, the TV tuner processing unit 114, the radio tuner processing unit 116, and the AV processing unit 118 into analog sound signals and outputs the converted sound signals from the speaker 142.

The control unit 150 functions to control the onboard device 4 as a whole and is embodied by causing the CPU to execute a predetermined program stored in the ROM or the RAM. The USB interface unit 180 functions to input and output a signal to and from the portable terminal device 1 or the like via a USB cable. The USB interface unit 180 includes a USB port or a USB host controller.

The control unit 150 includes a destination setting unit 151, a moving direction determining unit 152, a moving direction and destination transmitting unit 153, and an event venue receiving unit 154.

The destination setting unit 151 sets a destination when the navigation processing unit 110 performs a route searching process. It can be considered that a facility extracted by a facility search is set as a destination, that an event venue sent from the event venue transmitting unit 20 of the portable terminal device 1 is set as a destination, or the like.

The moving direction determining unit 152 determines a moving direction of the vehicle equipped with the onboard device 4. For example, when a travel route to the destination is set, an accurate moving direction can be determined. However, when the travel route is not set, a rough range in the front of the vehicle (for example, a range of 90° from right to left with respect to the front surface of the vehicle) is determined as the moving direction.

The moving direction and destination transmitting unit 153 transmits moving direction and destination data including the destination (which is excluded when the destination is an event venue sent from the portable terminal device 1) set by the destination setting unit 151 or the moving direction determined by the moving direction determining unit 152 to the portable terminal device 1.

The event venue receiving unit 154 receives location information indicating the event venue sent from the portable terminal device 1 using the event venue transmitting unit 20.

The event information acquiring system according to this embodiment has the above-mentioned configuration, and the operation thereof will be described below.

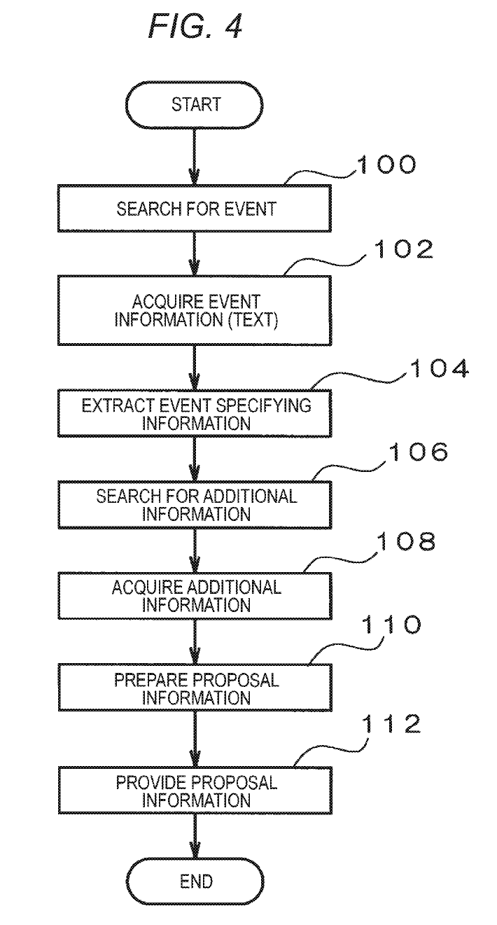

FIG. 4 is a flowchart illustrating an operation flow until the portable terminal device 1 acquires information on an event and provides proposal information.

First, the event information acquiring unit 12 roughly designates an event name, a date, a venue, and the like, searches for an event over the Internet (step 100), and acquires event information including text as a search result (step 102). It is desirable that the search in step 100 be performed in consideration of a user's hobby or taste specified by the hobby and taste specifying unit 19. For example, when the hobby is “fishing,” it is considered that “fishing” is designated as the rough event name. Accordingly, it is possible to acquire information of an event to which there is a high possibility that the user wants to attend and to provide proposal information for the event in which the user is interested.

Then, the event specifying information extracting unit 14 extracts event specifying information for specifying the event which is held on the basis of the event information acquired by the event information acquiring unit 12 (step 104). For example, a correct event name, a correct date, a correct venue, and the like are extracted as the “event specifying information.” The additional information acquiring unit 15 searches for additional information including an image such as a photograph corresponding to the event (step 106) and acquires the additional information (step 108) by designating the extracted event specifying information and accessing an API of a web site of the SNS server 3.

Then, the proposal information providing unit 16 prepares proposal information using the event information acquired by the event information acquiring unit 12 and the additional information acquired by the additional information acquiring unit 15 (step 110) and provides the proposal information to the user (step 112). In this way, a series of operations until the information on the event is acquired and the proposal information is provided ends.

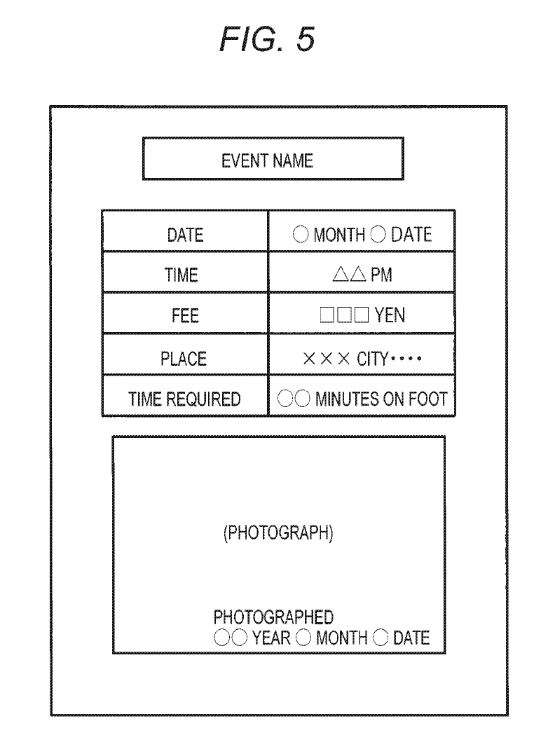

FIG. 5 is a diagram illustrating a display example of proposal information. The proposal information is presented to the user by displaying the proposal information on the display unit 42. The proposal information illustrated in FIG. 5 includes an event name, a date (a date on which the event is held), a time (a time at which the event is held), a fee (a usage fee or a participation fee), a place (a place in which the event is held), a required time (a required time from a current location), and a photograph to which a photographing date and time is added. Among these, a rough value of the “required time” can be calculated on the basis of a straight distance from the current location detected by the current location detecting unit 17 to the place in which the event is held, but the correct required time may be acquired by installing a map application in the portable terminal device 1 and calculating a travel route from the current location to the place in which the event is held through the route searching process.

In this way, the portable terminal device 1 according to this embodiment can easily acquire an image corresponding to a specific event from a specific web site by acquiring event information which is widely present over the Internet, then specifying an event on the basis of the event information, and additionally designating the specific web site (the SNS server 3). Since a useless image such as an advertisement can be easily excluded by restricting a web site (which is not limited to one) from which an image is acquired, useful event information including the image can be provided to the user via the Internet. It is not necessary to prepare an individual program for each of many web sites which are present over the Internet and it is possible to reliably acquire event information including a relevant image.

Particularly, since a web site equipped with an API often prepares event-relevant photographs to be provided to users, it is possible to reliably acquire images such as photographs corresponding to an event by acquiring additional information from such a web site. Particularly, since event-relevant photographs which are contributed by a third party and the like are widely opened in a web site providing an SNS, it is possible to reliably acquire images such as photographs corresponding to an event by acquiring additional information from such a web site.

The present invention is not limited to the above-mentioned embodiment, but can be modified in various forms without departing from the scope of the present invention. For example, in the above-mentioned embodiment, the event specifying information is extracted using the acquired event information (step 104 in FIG. 4) after the event information is acquired (step 102 in FIG. 4), but when the number of pieces of event information acquired in step 102 is large, some event information may be selected using a predetermined selecting condition before extracting the event specifying information.

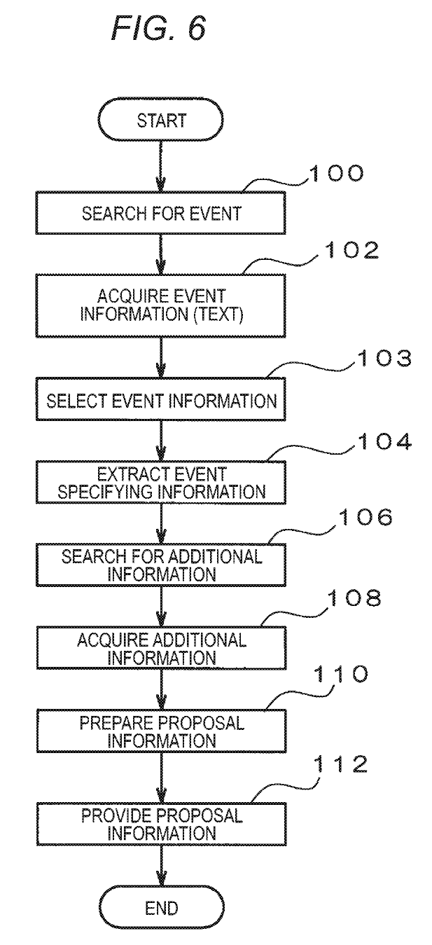

FIG. 6 is a flowchart illustrating an operation flow of selecting event information in a modified example. The operation flow illustrated in FIG. 6 is different from the operation flow illustrated in FIG. 4, in that step 103 is added between step 102 and step 104. Hereinafter, step 103 added herein will be described.

After acquiring of event information by the event information acquiring unit 12 (step 102) is completed, the event information selecting unit 13 selects some event information among the acquired event information using a predetermined selecting condition (step 103). Thereafter, event specifying information is extracted in step 104.

As a method of selecting event information using the event information selecting unit 13 in step 103, several methods described below are considered.

(1) The event information selecting unit 13 selects event information by restricting a date of an event. Accordingly, it is possible to provide a user with proposal information for an event which is held at an available date.

(2) The event information selecting unit 13 selects event information on the basis of a current location (a current location detected by the current location detecting unit 17) or a registered address (address information stored in the memory 70) of a user. For example, an event which is held within ◯◯ km from the current location or the registered address may be selected, or an event which is held in an administrative division (city, town, village, or the like) including the current location or the registered address may be selected. Accordingly, it is possible to provide a user with proposal information for an event which is held in an available place.

(3) The event information selecting unit 13 selects event information on the basis of a moving direction or a destination (this information is acquired by the moving direction and destination acquiring unit 18) of a vehicle of a user. For example, an event which is held within a predetermined range in the moving direction from the current location may be selected or an event which is held within a predetermined range from a destination or in an administrative division including the destination may be selected. Accordingly, it is possible to provide a user with proposal information for an event to which the user can travel by car.

(4) The event information selecting unit 13 selects event information by restriction to an event for which a fee (a participation fee or a usage fee) is equal to or less than a predetermined amount of money. Accordingly, it is possible to provide a user with proposal information for an event which is free of charge or requires a little cost.

(5) The event information selecting unit 13 selects event information in combination of at least two of (1) to (4).

In this way, it is possible to appropriately select event information among many acquired pieces of event information using the event information selecting unit 13 and to provide selected proposal information to a user.

In the above-mentioned embodiment, the operation flow until the portable terminal device 1 provides proposal information relevant to an event to a user has been described, but location information indicating a venue of an event corresponding to the proposal information provided by the proposal information providing unit 16 may be transmitted to the onboard device 4 that performs a navigation operation of guiding traveling of a vehicle along a travel route to a destination corresponding to the location information.

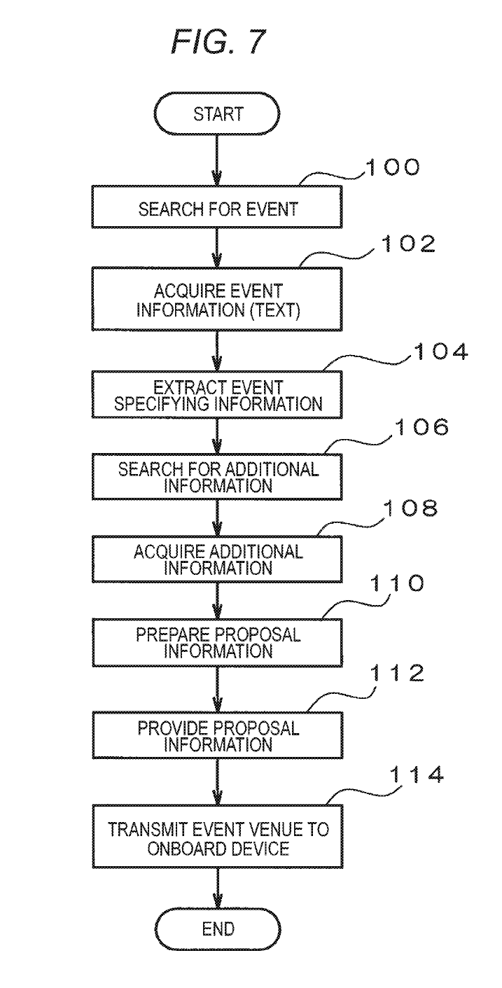

FIG. 7 is a flowchart illustrating an operation flow of transmitting location information indicating an event venue to the onboard device 4 in a modified example. The operation flow illustrated in FIG. 7 is different from the operation flow illustrated in FIG. 4, in that step 114 is added after step 112. Step 114 added herein will be described below.

After proposal information is provided to a user (step 112), the event venue transmitting unit 20 transmits information indicating an event venue included in the proposal information to the onboard device 4 (step 114). In the onboard device 4 having received the information, the destination setting unit 151 sets the event venue as a destination automatically or in accordance with a user's operation instruction to perform route search and guidance. Accordingly, the user provided with the proposal information can cause the vehicle to travel to the event venue without performing a complicated operation (for example, an operation of inputting an address of the event or the like to the onboard device while watching the proposal information).

In the above-mentioned embodiment, the proposal information including an image such as a photograph which is acquired as the additional information is presented to the user, but when an event is repeatedly held a plurality of times, an image included in the additional information is a photograph, and the photograph is taken to correspond to an event which is held prior to a previous event older than an event which is currently held, the proposal information may be provided to the user such that the user sees the effect. For example, in the specific example of proposal information illustrated in FIG. 5, a photographing date and time is added to a lower part of a photograph, but a character string such as “this photograph is an old one prior to the previous event” may be additionally added. Accordingly, when only old photographs are available, it is possible to prevent the user from mistaking the old photograph for a newest photograph.

In the above-mentioned embodiment, additional information including an image such as a photograph is acquired from the SNS server 3, but the additional information may be acquired from a specific server equipped with an API or a specific server not equipped with an API as a server other than the SNS server 3.

In the above-mentioned embodiment, additional event information including an image such as a photograph acquired as the additional information has been described, but the present invention may be applied to a case in which additional event information not including a photograph or the like is acquired.

In the above-mentioned embodiment, the operation flow until the portable terminal device 1 provides proposal information relevant to an event to a user has been described, but the onboard device 4 may have functions equivalent to the portable terminal device 1 and the onboard device 4 may perform a series of operations until proposal information relevant to an event is provided to a user. Alternatively, a series of operations until the proposal information is provided to a user may be performed by a personal computer or the like disposed indoors or the like.

According to the above-mentioned present disclosure, by acquiring event information which is present widely over the Internet, specifying an event on the basis of the event information, and additionally designating a specific web site, it is possible to easily acquire an image corresponding to a specific event from the specific web site. Particularly, by restricting a web site from which an image is acquired, it is possible to easily exclude a useless image such as an advertisement and it is thus possible to provide useful event information including an image to a user via the Internet.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. An event information presenting device which is realized by a control unit of an information processing terminal, the control unit comprising:
an event information acquiring unit configured to analyze text information which is present over the Internet via an Internet interface unit and to acquire event information;
an event specifying information extracting unit configured to extract event specifying information for specifying an event which is held on the basis of the event information;
an additional information acquiring unit configured to acquire additional information corresponding to the event from a specific web site via the Internet by designating the event specifying information; and
a proposal information providing unit configured to create proposal information using the event information and the additional information and to provide the created proposal information to a user.

2. The event information presenting device according to claim 1, wherein the additional information includes an image.

3. The event information presenting device according to claim 1, wherein the additional information acquiring unit acquires the additional information from a web site which is equipped with an application programming interface.

4. The event information presenting device according to claim 1, wherein the additional information acquiring unit acquires the additional information from a web site which provides a social networking service.

5. The event information presenting device according to claim 1, further comprising an event information selecting unit configured to select some event information from a plurality of pieces of the event information acquired by the event information acquiring unit using a predetermined selecting condition,
wherein the event specifying information extracting unit extracts the event specifying information from the event information selected by the event information selecting unit.

6. The event information presenting device according to claim 5, wherein the event information selecting unit selects the event information by restricting a date of an event.

7. The event information presenting device according to claim 5, wherein the event information selecting unit selects the event information on the basis of a user's current location or registered address.

8. The event information presenting device according to claim 5, wherein the event information selecting unit selects the event information on the basis of a moving direction or a destination of a user's vehicle.

9. The event information presenting device according to claim 5, wherein the event information selecting unit selects the event information by restriction to events in which a participation fee or a usage fee is equal to or less than a predetermined amount of money.

10. The event information presenting device according to claim 1, further comprising a hobby and taste specifying unit configured to specify a user's hobby or taste,
wherein the event information acquiring unit acquires event information relevant to a user's hobby or taste specified by the hobby and taste specifying unit.

11. The event information presenting device according to claim 1, wherein when an event corresponding to the additional information is held a plurality of times, a photograph is included in the additional information, and the photograph is selected to correspond to an event held prior to an event which is currently held, and the proposal information providing unit provides the proposal information such that the fact that the photograph is older is identified to a user.

12. The event information presenting device according to claim 1, wherein location information indicating a venue of an event corresponding to the proposal information provided from the proposal information providing unit is transmitted to an onboard device that performs a navigation operation of guiding traveling of a vehicle along a travel route to a destination corresponding to the location information.

13. An event information presenting method which is performed by an information processing terminal, the event information presenting method comprising:
causing an event information acquiring unit of a control unit of the information processing terminal to analyze text information which is present over the Internet via an Internet interface unit and to acquire event information;
causing an event specifying information extracting unit of the control unit of the information processing terminal to extract event specifying information for specifying an event which is held on the basis of the event information;
causing an additional information acquiring unit of the control unit of the information processing terminal to acquire additional information corresponding to the event from a specific web site via the Internet by designating the event specifying information; and
causing a proposal information providing unit of the control unit of the information processing terminal to create proposal information using the event information and the additional information and to provide the created proposal information to a user.

14. The event information presenting method according to claim 13, wherein the additional information includes an image.

15. The event information presenting method according to claim 13, wherein the additional information acquiring unit acquires the additional information from a web site which is equipped with an application programming interface or which provides a social networking service.

16. The event information presenting method according to claim 13, wherein an event information selecting unit is configured to select some event information from a plurality of pieces of the event information acquired by the event information acquiring unit using a predetermined selecting condition, and the event specifying information extracting unit extracts the event specifying information from the event information selected by the event information selecting unit.

17. The event information presenting method according to claim 16, wherein the event information selecting unit selects the event information by restricting a date of an event, on the basis of a user's current location or registered address, on the basis of a moving direction or a destination of a user's vehicle, or by restriction to events in which a participation fee or a usage fee is equal to or less than a predetermined amount of money.

18. The event information presenting method according to claim 13, wherein a hobby and taste specifying unit is configured to specify a user's hobby or taste, and the event information acquiring unit acquires event information relevant to a user's hobby or taste specified by the hobby and taste specifying unit.

19. The event information presenting method according to claim 13, wherein when an event corresponding to the additional information is held a plurality of times, a photograph is included in the additional information, and the photograph is selected to correspond to an event held prior to an event which is currently held, and the proposal information providing unit provides the proposal information such that the fact that the photograph is older is identified to a user.

20. The event information presenting method according to claim 13, wherein location information indicating a venue of an event corresponding to the proposal information provided from the proposal information providing unit is transmitted to an onboard device that performs a navigation operation of guiding traveling of a vehicle along a travel route to a destination corresponding to the location information.
